(19) United States
(12) Patent Application Publication
(10) Pub. No.: US 2021/0359309 A1
(43) Pub. Date: Nov. 18, 2021

(54) BATTERY CURRENT COLLECTOR, BATTERY, AND METHOD FOR PRODUCING BATTERY

(71) Applicant: Panasonic Intellectual Property Management Co., Ltd., Osaka (JP)

(72) Inventor: KAZUYA IWAMOTO, Osaka (JP)

(21) Appl. No.: 17/388,339

(22) Filed: Jul. 29, 2021

Related U.S. Application Data
(63) Continuation of application No. PCT/JP2020/001202, filed on Jan. 16, 2020.

(30) Foreign Application Priority Data
Mar. 27, 2019 (JP) 2019-061265

(51) Int. Cl. H01M 4/66; H01M 10/0562; H01M 10/058

(52) U.S. Cl. CPC H01M 4/668; H01M 10/058; H01M 10/0562; H01M 4/661

(57) ABSTRACT

A battery current collector includes: a first region having electron conductivity; a second region having insulating properties and located around the first region in plan view; and a third region located between the first region and the second region in plan view. The first region contains an insulating material and an electron conductive material, the second region contains the insulating material, and the third region contains the insulating material and a solid electrolyte.

### BACKGROUND

### 1. Technical Field

The present disclosure relates to a battery current collector, a battery, a method for producing the battery current collector, and a method for producing the battery.

### 2. Description of the Related Art

A battery current collector includes a material containing an electron conductive material, such as a metal. In this specification, a battery current collector may be hereinafter referred to simply as a “current collector”. Japanese Unexamined Patent Application Publication No. 2010-73500 (Patent Literature 1) discloses a current collector having an organic skeletal structure and a conductive material and having electron conductivity in the thickness direction. FIG. 1 is a view of the current collector disclosed in Patent Literature 1. As shown in FIG. 1, a current collector 11 includes a porous organic structure 1 having many pores interconnected to each other in the thickness direction and a conductive material 2 packed in the pores of the porous organic structure 1. The conductive material 2 includes a conductive filler 2a, such as metal powder, and a binder polymer 2b for binding particles of the conductive filler 2a to each other or binding and fixing the conductive filler 2a to the organic structure 1.

### SUMMARY

The use of the current collector of Patent Literature 1 in batteries may cause exposure of the conductive material from the organic structure when the current collector is cut to arrange the shape or may cause misalignment between the electrode layers and the current collectors during production or use of batteries although short-circuiting is unlikely to occur between the positive electrodes and the negative electrodes, increasing the need to further improve the reliability of batteries including current collectors.

One non-limiting and exemplary embodiment provides a battery current collector and the like for improving battery reliability.

In one general aspect, the techniques disclosed here feature A battery current collector includes: a first region having electron conductivity; a second region having insulating properties and located around the first region in plan view; and a third region located between the first region and the second region in plan view, where first region contains an insulating material and an electron conductive material, the second region contains the insulating material, and the third region contains the insulating material and a solid electrolyte.

The battery current collector according to the present disclosure can improve battery reliability.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a view of a current collector disclosed in Patent Literature 1;

FIG. 2A is a perspective view of one example of a current collector according to a first embodiment;

FIG. 2B is a perspective view of another example of the current collector according to the first embodiment;

FIG. 2C illustrates a plan view and a cross-sectional view of another example of the current collector according to the first embodiment;

FIG. 2D is a cross-sectional view of another example of the current collector according to the first embodiment;

FIG. 3A is a perspective view of an example of an insulating material used in a current collector according to Modification 1 of the first embodiment;

FIG. 3B illustrates a plan view and a cross-sectional view of one example of the current collector according to Modification 1 of the first embodiment;

FIG. 3C is a cross-sectional view of another example of the current collector according to Modification 1 of the first embodiment;

FIG. 4A is a perspective view of an example of an insulating material used in a current collector according to Modification 2 of the first embodiment;

FIG. 4B illustrates a plan view and a cross-sectional view of an example of the current collector according to Modification 2 of the first embodiment;

FIG. 5 illustrates a plan view and a cross-sectional view of an example of a current collector according to Modification 3 of the first embodiment;

FIG. 6 illustrates a plan view and a cross-sectional view of an example of a battery according to the second embodiment;

FIG. 7 illustrates a plan view and a cross-sectional view of an example of a battery according to Modification 1 of the second embodiment;

FIG. 8 illustrates a plan view and a cross-sectional view of an example of a battery according to Modification 2 of the second embodiment;

FIG. 9 illustrates a cross-sectional view of an example of a battery according to Modification 3 of the second embodiment and views of external connection examples;

FIG. 10 is a cross-sectional view of an example of a battery according to Modification 4 of the second embodiment;

FIG. 11A is a cross-sectional view of one example of a battery according to Modification 5 of the second embodiment; and

FIG. 11B is a cross-sectional view of another example of the battery according to Modification 5 of the second embodiment.

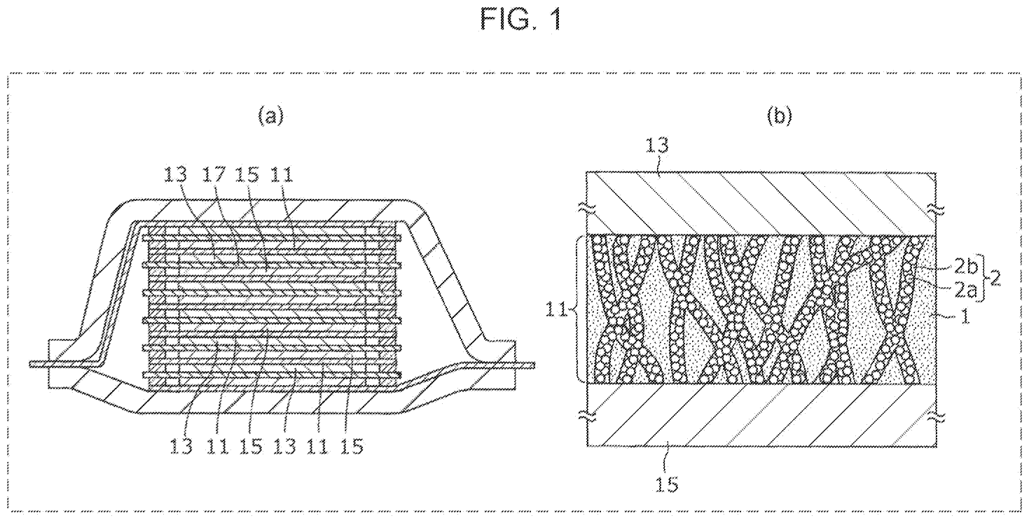

### DETAILED DESCRIPTION

### Summary of Present Disclosure

A battery current collector in an aspect of the present disclosure includes a first region having electron conductivity and a second region having insulating properties and located around the first region in plan view. The first region contains an insulating material and an electron conductive material. The second region contains the insulating material.

The use of the battery current collector according to the present disclosure in batteries prevents battery short-circuiting because the second region having insulating properties is disposed in the peripheral portion of the battery current collector to suppress short-circuiting even when the second region of one battery current collector comes into contact with another battery current collector or the like. Even when the second region in the peripheral portion of the battery current collector is cut to arrange the shape of the current collector, a part of the second region exposed by cutting maintains its insulating properties. Since the first region contains an electron conductive material and an insulating material, there is a large contact area between the insulating material and the electron conductive material when the electron conductive material is incorporated into the insulating material or supported on the insulating material as viewed in the thickness direction. As a result, the insulating material and the electron conductive material are strongly joined to each other, and the shape of the current collector tends to be maintained even when the current collector experiences impact or the like. This configuration can improve battery reliability.

The battery current collector further includes a third region located between the first region and the second region in plan view and containing the insulating material and a solid electrolyte.

When the battery current collector according to the present disclosure is used in batteries, and the third region is in contact with the solid electrolyte layer included in the power generating element, the solid electrolyte layer contained in the third region is easily bonded to the solid electrolyte contained in the solid electrolyte layer. This configuration provides batteries having a tightly laminated structure and prevents or reduces misalignment between the battery current collector and the power generating element. This configuration can further improve battery reliability.

For example, the insulating material may be a thermoplastic resin.

The use of such a resin enables processing of the insulating material by heating and cooling and thus facilitates production and post-processing of the battery current collector.

The thermoplastic resin may be, for example, polyethylene, polypropylene, or polyethylene terephthalate.

A material excellence in toughness, rigidity and workability is thus used in the first region and the like. The use of such a material facilitates production and post-processing of the battery current collector and suppresses fracture of the battery current collector.

For example, at least part of the insulating material of the first region may have multiple through-holes.

With such a configuration, the first region is formed only by packing the electron conductive material in the through-holes, which easily ensures the electron conductivity in the thickness direction.

For example, the electron conductive material may be a metal foil.

With such a configuration, the first region is formed by attaching a metal foil to the insulating material or sandwiching the insulating material between metal foils, and it is thus easy to adjust the joining conditions between the electron conductive material and the insulating material.

For example, the electron conductive material may be an aggregate of metal particles or carbon material particles.

The electron conductive material accordingly has a high degree of freedom in shape and makes it easy to produce the battery current collector even using an insulating material having a complicated shape.

A battery in an aspect of the present disclosure includes at least one first electrode current collector, at least one second electrode current collector, and at least one power generating element. The power generating element includes a first electrode layer, a second electrode layer, and a solid electrolyte layer disposed between the first electrode layer and the second electrode layer. The power generating element is laminated between and in contact with the first electrode current collector and the second electrode current collector. At least one of the first electrode current collector or the second electrode current collector is the battery current collector described above.

This provides a battery including the battery current collector. Since a peripheral portion of at least one of the first electrode current collector or the second electrode current collector has the second region having insulating properties, short-circuiting is unlikely to occur even when the first electrode current collector comes into contact with the second electrode current collector. This configuration can improve battery reliability.

For example, in the battery, the at least one power generating element may include multiple power generating elements, and each of the power generating elements may be laminated between and in contact with the corresponding first electrode current collector and the corresponding second electrode current collector.

This configuration forms a laminated battery, and a battery with a high voltage or a high capacity is achieved by series connection or parallel connection.

For example, the first electrode current collector and the second electrode current collector may be both the battery current collectors described above, and the second region of the first electrode current collector may be at least partially joined to the second region of the second electrode current collector.

Thus, the side surfaces of the power generating element are also covered with the insulating material, which prevents contact of the power generating element with other batteries. This configuration can further improve battery reliability.

For example, an insulating layer made of the insulating material may be formed in a top surface portion of the first electrode current collector or the second electrode current collector laminated as the uppermost layer, or in a bottom surface portion of the first electrode current collector or the second electrode current collector laminated as the lowermost layer.

The insulating layer is thus formed in the top surface portion of the current collector laminated as the uppermost layer, or in the bottom surface portion of the current collector laminated as the lowermost layer. This configuration can further reduce the area of regions having electron conductivity on the outer surfaces of batteries. This configuration can further reduce possibility of short-circuiting caused by contact between batteries to improve battery reliability.

A method for producing a battery current collector in an aspect of the present disclosure includes: preparing a thin film that is an insulating material having at least one through-hole; and forming a first region and a second region around the first region in plan view by disposing an electron conductive material in a region including the through-hole. The first region has electron conductivity and contains the insulating material and the electron conductive material. The second region has insulating properties and contains the insulating material.

This method can produce the battery current collector having the second region having insulating properties disposed in the peripheral portion of the battery current collector. A battery including the battery current collectors thus produced does not cause short-circuiting even when the second region of one current collector comes into contact with another current collector or the like. This configuration can suppress battery short-circuiting to improve battery reliability.

For example, the at least one through-hole in the thin film may include multiple through-holes. The first region may be formed by applying a paste containing the electron conductive material to the multiple through-holes.

The application of the paste containing the electron conductive material causes the electron conductive material to be packed in the through-holes to form the first region. The battery current collector having the first region and the second region can thus be easily produced.

A method for producing a battery in an aspect of the present disclosure includes: forming a first electrode layer and a second electrode layer; and laminating a power generating element between a first electrode current collector and a second electrode current collector. The power generating element includes the first electrode layer, the second electrode layer, and a solid electrolyte layer disposed between the first electrode layer and the second electrode layer. At least one of the first electrode current collector or the second electrode current collector is the battery current collector described above.

The battery including the battery current collectors described above can be produced accordingly. In the battery thus produced, the second region having insulating properties is disposed in a peripheral portion and suppresses short-circuiting even when the first electrode current collector comes into contact with the second electrode current collector. This configuration can improve battery reliability.

For example, the first electrode current collector and the second electrode current collector may be both the battery current collectors described above, and the method may further include thermally fusing at least part of the second region of the first electrode current collector to at least part of the second region of the second electrode current collector.

This method can produce the battery in which the second region of the first electrode current collector is thermally fused and joined to the second region of the second electrode current collector. Since the side surfaces of the power generating element are also covered with the insulating material in the battery thus produced, the insulating material can prevent contact of the power generating element with other batteries. This configuration can further improve battery reliability.

Embodiments of the present disclosure will be described below with reference to the drawings.

Any embodiment described below illustrates comprehensive or specific examples. The values, shapes, materials, components, the arrangement positions and connection configuration of the components, steps, the sequence of the steps, and the like described in the following embodiments are illustrative only and should not be construed as limiting the present disclosure. Among the components in the following embodiments, the components that are not mentioned in the independent claims are described as optional components.

The drawings are all schematic views and are not necessarily accurately drawn. Therefore, for example, the drawings are not necessarily drawn to scale. In the drawings, components having substantially the same function are denoted by the same reference characters, and the redundant description thereof is omitted or simplified.

In this specification, the terms expressing the relationship between elements, such as parallel, the terms expressing the shapes of elements, such as rectangle, and the numerical ranges are not expressions having only strict meanings but expressions having meanings in a substantially equivalent range, for example, including a difference of about several percentages.

In this specification and drawings, the x-axis, y-axis, and z-axis represent three axes in a three-dimensional cartesian coordinate system. In each embodiment, the z-axis direction is the thickness direction of a current collector and a battery. The term “thickness direction” in this specification refers to the direction perpendicular to the main surface of a current collector and the main surface of each layer constituting a battery. The term “plan view” in this specification refers to the view of a current collector or battery in the thickness direction.

### First Embodiment

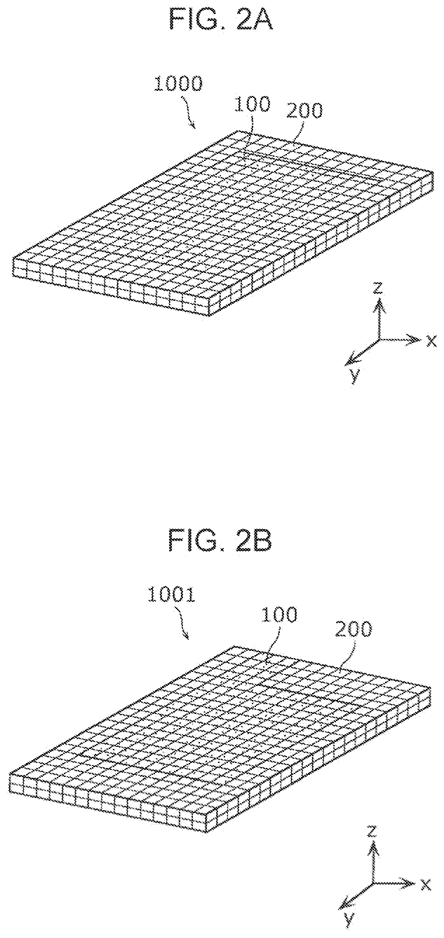

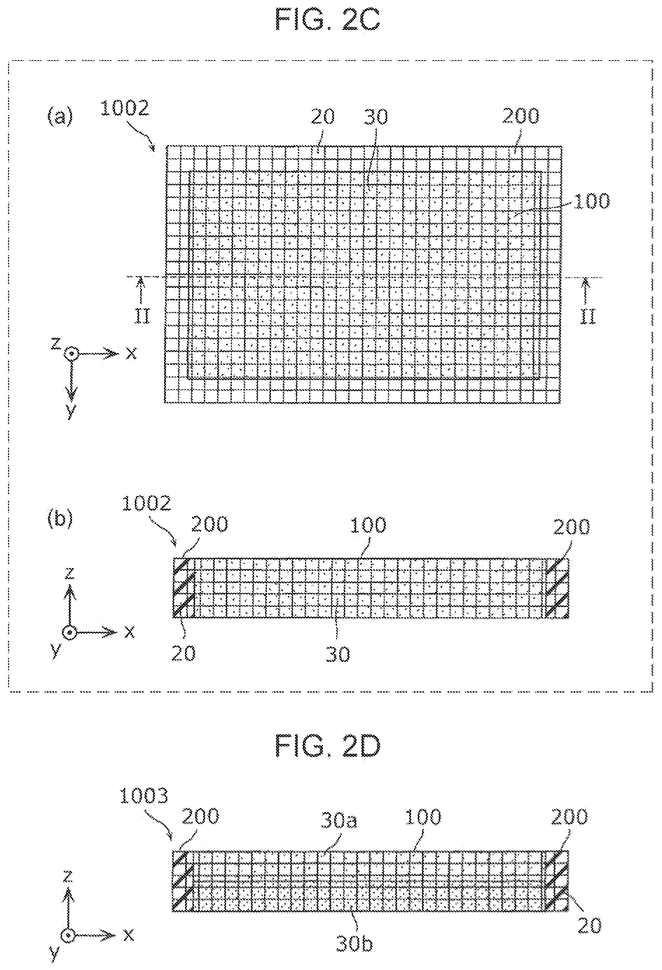

A current collector according to a first embodiment will be described with reference to FIG. 2A, FIG. 2B, FIG. 2C, and FIG. 2D. FIG. 2A is a perspective view of one example of the current collector according to the first embodiment. FIG. 2B is a perspective view of another example of the current collector according to the first embodiment. FIG. 2C illustrates a plan view and a cross-sectional view of another example of the current collector according to the first embodiment. FIG. 2D is a cross-sectional view of another example of the current collector according to the first embodiment.

Referring to FIG. 2A, a current collector 1000 according to a first embodiment is a plate-shaped battery current collector. The current collector 1000 may have any shape as long as the current collector 1000 can be used as a current collector for batteries. The current collector 1000 may have a plate shape, a film shape, or other shapes such that layers for batteries can be laminated on the current collector. The current collector 1000 includes a first region 100 having electron conductivity and a second region 200 having insulating properties and located around the first region 100 in plan view. The first region 100 contains an insulating material and an electron conductive material, and the second region 200 contains an insulating material. In the current collector 1000, the periphery of the first region 100 is completely covered with the second region 200. The entire peripheral portion of the current collector 1000 is formed of the second region 200. The first region 100 has electron conductivity at least in the thickness direction of the current collector 1000 and allows current to flow in the thickness direction from an electrode layer when the current collector 1000 is used in batteries. In other words, the first region 100 is a region to be in contact with the electrode layer when the current collector 1000 is used in batteries, and the first region 100 is used to draw current from the electrode layer to the outside or establish electrical connection with another electrode layer.

The insulating material in this specification is a material having insulation against electrons and ions. The insulation is a property of having insulation against electrons and ions. Examples of the insulating material include inorganic materials, such as ceramics and glass, having no electron or ion conductivity, and organic polymer materials having no electron or ion conductivity. Since the current collector is preferably light in weight and thin in order to increase the battery energy density, the insulating material may be an organic polymer material having no electron or ion conductivity, which is easy to process and easily reduced in weight and thickness. To facilitate processing and thermal fusion between the insulating materials of the current collectors 1000, the organic polymer material may be a thermoplastic resin. Examples of the thermoplastic resin include polyethylene, polypropylene, polyethylene terephthalate, polystyrene, vinyl chloride resin, and acrylic resin. Among these, the thermoplastic resin may be a crystalline polymer material, such as polyethylene, polypropylene, or polyethylene terephthalate from the viewpoint of toughness, rigidity, and workability. The shape of the insulating material will be described below.

The insulating material may be a single material or may be a mixture of materials. The insulating material contained in the first region 100 and the insulating material contained in the second region 200 may be the same in shape and material type or may be different in shape and material type. To tightly form the first region 100 and the second region 200, the insulating material contained in the first region 100 may be integrated with the insulating material contained in the second region 200.

Examples of the electron conductive material include metals, such as aluminum, copper, and stainless steel, and carbon materials, such as acetylene black, carbon black, graphite, carbon fiber, graphene, and carbon nanotubes. The metal used as the electron conductive material may be copper or stainless steel when the current collector 1000 is used as a negative electrode current collector, or may be aluminum or stainless steel when the current collector 1000 is used as a positive electrode current collector. The shape of the electron conductive material will be described below.

The current collector 1000 has, for example, a thickness greater than or equal to 5 μm and less than or equal to 100 μm, but the thickness is not limited to this.

Referring to FIG. 2B, in a current collector 1001 according to the first embodiment, no second region 200 is disposed on part of the periphery of a first region 100 in plan view, and part of the first region 100 extends to the edge portion of the current collector 1001. The current collector 1001 has electron conductivity at least in the direction perpendicular to the thickness direction. When the current collector 1001 is used in batteries, current can be drawn from the edge portion of the current collector 1001 in which part of the first region 100 is formed.

FIG. 2C(a) is a plan view of a current collector 1002 according to the first embodiment. FIG. 2C(b) is a cross-sectional view of the current collector 1002 taken along II-II line in FIG. 2C(a). Referring to FIG. 2C(a), the current collector 1002 includes a first region 100 and a second region 200 located around the first region 100 in plan view. The current collector 1002 and the first region 100 have a rectangular shape in plan view, and the second region 200 has a rectangular annular shape. Referring to FIG. 2C(b), the first region 100 and the second region 200 extend from the top surface to the bottom surface of the current collector 1002 in the thickness direction (z-axis direction). In the current collector 1002, the first region 100 and the second region 200 are formed by packing particles of an electron conductive material 30 in through-holes of an insulating material 20, which has multiple through-holes formed throughout, on the central side in plan view. Specifically, in the first region 100, the insulating material 20 has multiple through-holes penetrating from the top surface of the bottom surface in the thickness direction (z-axis direction). In the first region 100, the electron conductive material 30 is packed in the through-holes of the insulating material 20. This configuration allows the first region 100 to have electron conductivity at least in the thickness direction. In the first region 100, the electron conductive material 30 may be an aggregate of metal particles or carbon material particles.

In the first region, the electron conductive material is not necessarily incorporated into the insulating material and may be supported on the insulating material as viewed in the thickness direction. In other words, the first region contains the insulating material and the electron conductive material as viewed in the thickness direction. The electron conductive material is exposed on at least one of the top surface or the bottom surface of the first region in the thickness direction.

The insulating material 20 is preferably, for example, a mesh, porous, or nonwoven insulating material. When the first region 100 is formed by application of a conductive paste or fusion of a metal foil to the through-holes, the insulating material 20 may be a mesh material since the through-holes are preferably not complicated. When the first region 100 extends to the edge portion of the current collector 1001 in plan view, and current is drawn from the edge portion of the current collector 1001, like the current collector 1001 as shown in FIG. 2B, the insulating material may have three-dimensionally interconnected pores such that the electron conductive material is easily packed in the pores both in the thickness direction and in the direction perpendicular to the thickness direction to ensure electron conductivity both in the thickness direction and in the direction perpendicular to the thickness direction.

In the second region 200, the insulating material 20 similarly has multiple through-holes penetrating from the top surface to the bottom surface in the thickness direction (z-axis direction).

Referring to FIG. 2D, a current collector 1003 according to the first embodiment includes a first region 100 and a second region 200 located around the first region 100 in plan view. In the current collector 1003, the first region 100 contains two different electron conductive materials: an electron conductive material 30a and an electron conductive material 30b. Specifically, the first region 100 contains the insulating material 20 and the electron conductive material 30a on the top surface side in the thickness direction and contains the insulating material 20 and the electron conductive material 30b on the bottom surface side in the thickness direction. Since different electron conductive materials are contained on the top surface side and on the bottom surface side, electron conductive materials suitable for the top surface side and the bottom surface side can be used when the current collector 1003 is used in batteries and has different electrode materials laminated on the top surface side and the bottom surface side.

The current collectors according to the first embodiment are produced by, for example, the following method.

First, a thin film that is an insulating material having multiple through-holes formed throughout, such as the insulating material 20 shown in FIG. 2C, is prepared. Next, a paste containing an electron conductive material, such as a metal or a carbon material, is applied to a region having multiple through-holes to form a first region 100 and a second region 200 in plan view as in, for example, the current collector 1002 shown in FIG. 2C. The first region 100 has electron conductivity and contains the insulating material and the electron conductive material. The second region 200 has insulating properties, is located around the first region 100 in plan view, and contains the insulating material. The paste containing a metal or a carbon material is, for example, a paste containing metal particles or carbon material particles dispersed in an organic solvent or an adhesive polymer. The electron conductive material is packed in the through-holes of the insulating material by applying the paste containing the electron conductive material to the insulating material. The obtained battery current collector may be dried as desired.

### Modifications

Hereinafter, modifications of the first embodiment will be described below. In the description of the modifications below, the points different from the first embodiment or the different points between the modifications will be mainly described, and description of common points will be omitted or simplified.

### Modification 1

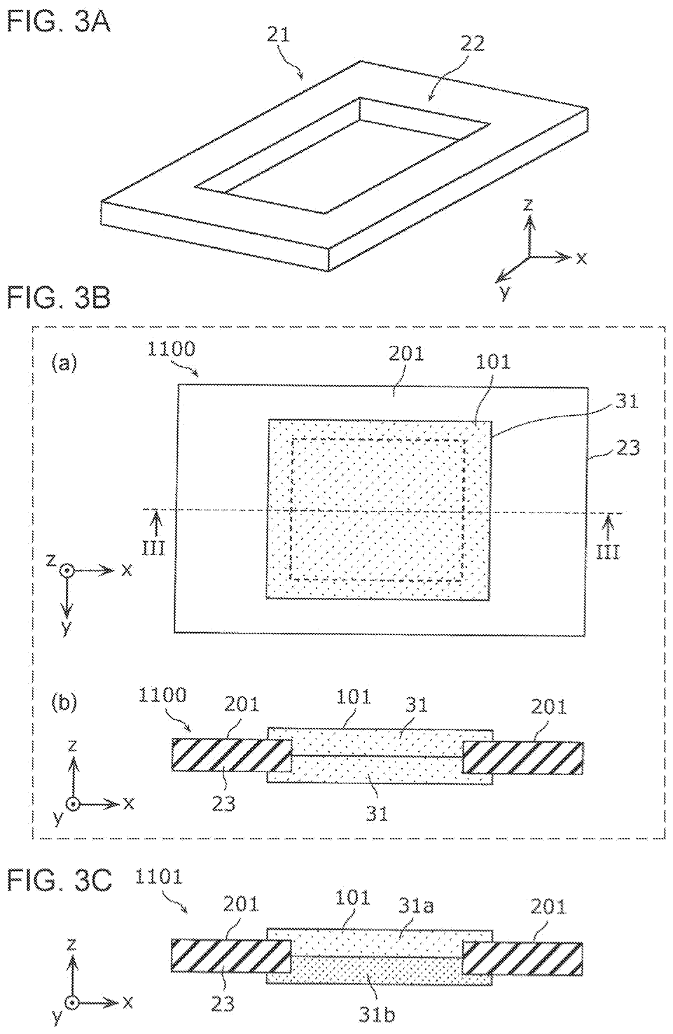

FIG. 3A is a perspective view of an example of an insulating material used in a current collector according to Modification 1 of the first embodiment. FIG. 3B illustrates a plan view and a cross-sectional view of one example of the current collector according to Modification 1 of the first embodiment. FIG. 3C is a cross-sectional view of another example of the current collector according to Modification 1 of the first embodiment. The current collector according to Modification 1 of the first embodiment is different from the current collector according to the first embodiment in the form of through-hole in the insulating material used for the current collector.

In the first embodiment, multiple through-holes are formed throughout the insulating material. In Modification 1 of the first embodiment, a frame-shaped insulating material 21 is used as shown in FIG. 3A. In other words, the insulating material 21 has one through-hole 22. In the current collector according to Modification 1 of the first embodiment, a first region is formed such that the through-hole 22 is located on the inner side of the first region in plan view.

FIG. 3B(a) is a plan view of a current collector 1100 according to Modification 1 of the first embodiment. FIG. 3B(b) is a cross-sectional view of the current collector 1100 taken along III-III line in FIG. 3B(a).

Referring to FIG. 3B, the current collector 1100 includes a first region 101 having electron conductivity and a second region 201 having insulating properties and located around the first region 101 in plan view. The first region 101 contains an insulating material 23 and an electron conductive material 31, and the second region 201 contains the insulating material 23. As shown in FIG. 3B(b), the first region 101 of the current collector 1100 is formed such that a region of the frame-shaped insulating material 23 including the through-hole part is sandwiched between two film-shaped electron conductive materials 31. Specifically, each electron conductive material 31 may be a metal foil. Part of each electron conductive material 31 in the first region 101 is thus supported on the insulating material 23 as viewed in the thickness direction. In the first region 101, the through-hole part of the insulating material 23 is a region that contains the electron conductive materials 31 but does not contain the insulating material 23. This configuration can improve the electron conductivity in the first region 101.

In the second region 201, the insulating material 23 has no through-hole.

Referring to FIG. 3C, a current collector 1101 according to Modification 1 of the first embodiment includes a first region 101 and a second region 201 located around the first region 101 in plan view. In the current collector 1101, the first region 101 contains two different electron conductive materials: an electron conductive material 31a and an electron conductive material 31b. The first region 101 of the current collector 1101 is formed such that a region of the frame-shaped insulating material 23 including the through-hole part is sandwiched between two film-shaped electron conductive materials: the electron conductive material 31a and the electron conductive material 31b. Specifically, in the first region 101, the electron conductive material 31a is supported on part of the insulating material 23 on the top surface side in the thickness direction, and the electron conductive material 31b is supported on part of the insulating material 23 on the bottom surface side in the thickness direction.

The current collectors according to Modification 1 of the first embodiment are produced by, for example, the following method.

First, a thin film that is a frame-shaped insulating material having one through-hole at the center, such as the insulating material 21 shown in FIG. 3A, is prepared. Next, two metal foils are attached to a region including the through-hole from above and below in the thickness direction to form a first region 101 and a second region 201 in plan view as in, for example, the current collector 1100 shown in FIG. 3B. The first region 101 has electron conductivity and contains the insulating material and an electron conductive material. The second region 201 has insulating properties, is located around the first region 101 in plan view, and contains the insulating material.

The metal foils can be attached by using a known method, such as a method using resistance welding, ultrasonic welding, a conductive double-sided tape, or a conductive paste.

### Modification 2

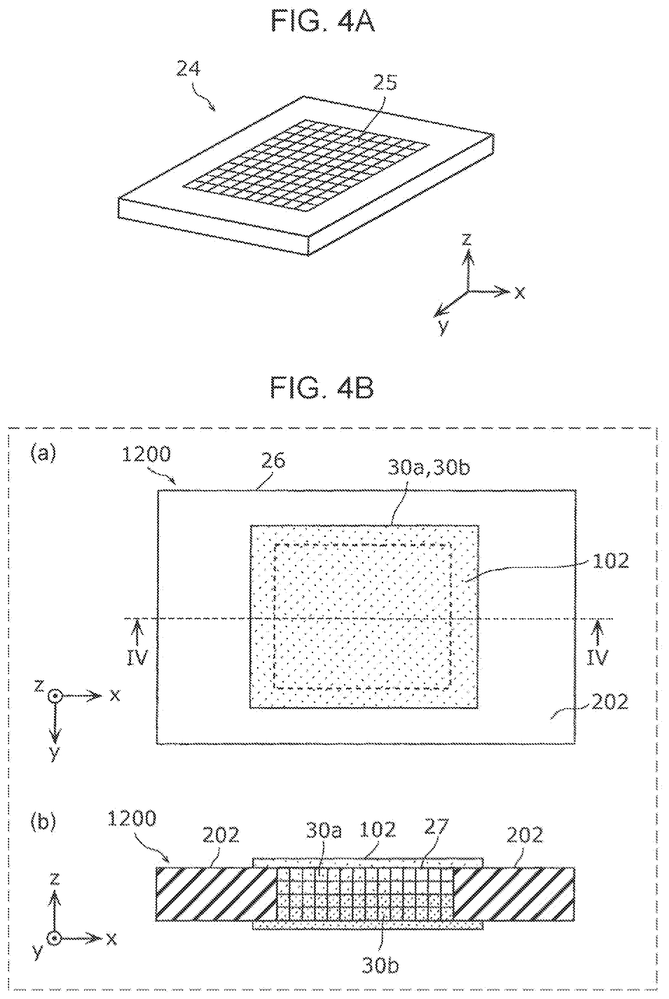

FIG. 4A is a perspective view of an example of an insulating material used in the current collector according to Modification 2 of the first embodiment. FIG. 4B illustrates a plan view and a cross-sectional view of an example of the current collector according to Modification 2 of the first embodiment. The current collector according to Modification 2 of the first embodiment is different from the current collector according to the first embodiment in the form of through-hole in the insulating material used for the current collector.

In the first embodiment, multiple through-holes are formed throughout the insulating material for forming the current collector. In Modification 2 of the first embodiment, an insulating material 24 having multiple through-holes is used only in a region 25 on the central side in plan view as shown in FIG. 4A. In the current collector according to Modification 2 of the first embodiment, a first region is formed such that the region 25 is located on the inner side of the first region in plan view.

FIG. 4B(a) is a plan view of a current collector 1200 according to Modification 2 of the first embodiment. FIG. 4B(b) is a cross-sectional view of the current collector 1200 taken along IV-IV line in FIG. 4B(a).

Referring to FIG. 4B(a), the current collector 1200 includes a first region 102 having electron conductivity and a second region 202 having insulating properties and located around the first region 102 in plan view. The first region 101 contains an insulating material 26, an electron conductive material 30a, and an electron conductive material 30b, and the second region 202 contains the insulating material 26. Referring to FIG. 4B(b), the first region 102 contains the insulating material 26 and the electron conductive material 30a on the top surface side in the thickness direction and contains the insulating material 26 and the electron conductive material 30b on the bottom surface side in the thickness direction. The electron conductive material 30a and the electron conductive material 30b are packed in multiple through-holes formed in the insulating material 26. Part of the electron conductive material 30a and part of the electron conductive material 30b are supported in a region 27 of the insulating material 26 that has multiple through-holes and a region outside the region 27, as viewed in the thickness direction. The electron conductive material 30a and the electron conductive material 30b are composed of, for example, metal particles or carbon material particles.

As described above, according to the battery current collectors according to the first embodiment, Modification 1 of the first embodiment, and Modification 2 of the first embodiment, the second region containing the insulating material and having insulating properties is disposed in the periphery of a battery when the current collector is used in the battery. This configuration prevents short-circuiting even when the second region comes into contact with the first region of the adjacent current collector or the like, which suppresses battery short-circuiting. Since the electron conductive material in the first region is incorporated into the insulating material or supported on the insulating material as viewed in the thickness direction, there is a large contact area between the insulating material and the electron conductive material. As a result, the insulating material and the electron conductive material are strongly joined to each other, and the shape of the current collector tends to be maintained even when the current collector experiences impact or the like. This configuration can improve battery reliability.

### Modification 3

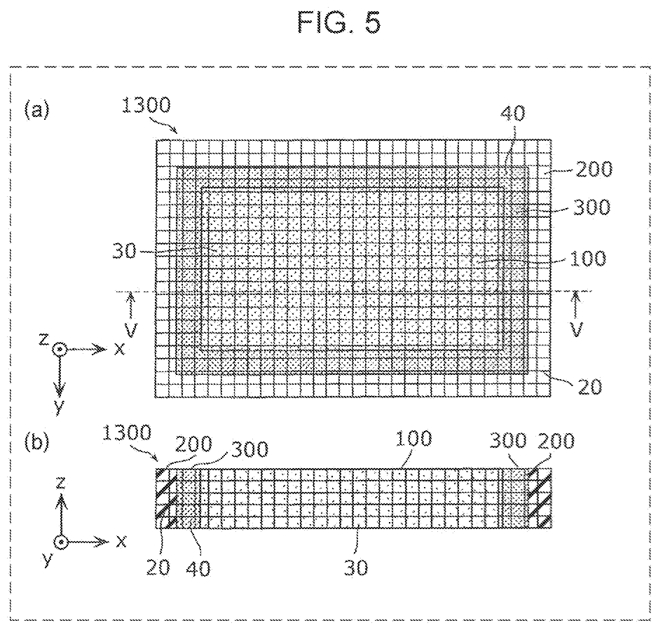

FIG. 5 illustrates a plan view and a cross-sectional view of an example of a current collector according to Modification 3 of the first embodiment. The current collector according to Modification 3 of the first embodiment is different from the current collector according to the first embodiment in having a third region containing an insulating material and a solid electrolyte.

FIG. 5(a) is a plan view of a current collector 1300 according to Modification 3 of the first embodiment. FIG. 5(b) is a cross-sectional view of the current collector 1300 taken along V-V line in FIG. 5(a).

Referring to FIG. 5, the current collector 1300 according to Modification 3 of the first embodiment includes a first region 100 and a second region 200. The first region 100 has electron conductivity and contains an insulating material 20 and an electron conductive material 30. The second region 200 has insulating properties, is located around the first region 100 in plan view, and contains the insulating material 20. The current collector 1300 further includes a third region 300. The third region 300 is located between the first region 100 and the second region 200 in plan view and contains the insulating material 20 and a solid electrolyte 40. Referring to FIG. 5(b), the third region 300 extends from the top surface to the bottom surface in the thickness direction (z-axis direction). The third region 300 of the current collector 1300 is formed by packing particles of the solid electrolyte 40 in multiple through-holes formed in the insulating material 20.

Referring to FIG. 5(b), the third region 300 is formed by packing the solid electrolyte 40 in multiple through-holes formed in the insulating material 20. In the third region 300, the solid electrolyte 40 is not necessarily incorporated into the insulating material and may be supported on the insulating material as viewed in the thickness direction. In other words, the third region contains the insulating material and the solid electrolyte as viewed in the thickness direction. The solid electrolyte 40 is exposed on at least one of the top surface or the bottom surface of the third region 300 in the thickness direction.

The solid electrolyte 40 is a material having ion conductivity and having insulation against electrons. Examples of the solid electrolyte 40 may include solid electrolytes, such as inorganic solid electrolytes. Examples of inorganic solid electrolytes may include sulfide solid electrolytes, oxide solid electrolytes, and halide solid electrolytes. Examples of sulfide solid electrolytes include a mixture of lithium sulfide (Li₂S) and phosphorus pentasulfide (P₂S₅).

The insulating material contained in the first region 100 and the second region 200 may be different from or the same as the insulating material contained in the third region 300 in shape and material type. To tightly form the first region 100, the second region 200, and the third region 300, the insulating material contained in the first region 100, the insulating material contained in the second region 200, and the insulating material contained in the third region 300 may be integrated with one another.

The third region 300 can be formed by using the same method as the method for forming the first region in the method for producing the current collectors according to the first embodiment and Modifications of the first embodiment except that the electron conductive material is changed to the solid electrolyte and the solid electrolyte is disposed between the first region and the second region.

When the current collector 1300 is used in batteries, the third region 300 in the current collector 1300 improves the adhesion between a battery power generating element, particularly a solid electrolyte layer, and the solid electrolyte 40 of the third region 300 to reduce possibility of misalignment between the power generating element and the current collector during production or use of batteries. The current collector 1300 can further improve battery reliability.

### Second Embodiment

Hereinafter, a second embodiment will be described below. In the following description, the points different from the first embodiment and the modifications described above will be mainly described, and description of common points will be omitted or simplified as appropriate.

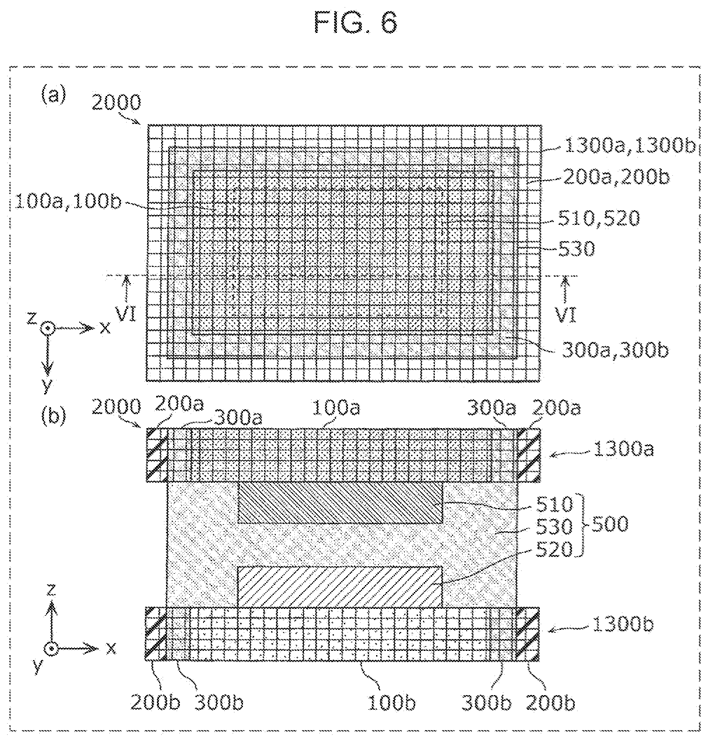

FIG. 6 illustrates a plan view and a cross-sectional view of an example of a battery according to the second embodiment. The battery according to the second embodiment includes the current collector according to any one of the first embodiment and the modifications described above. In other words, the current collector of the battery according to second embodiment includes the first region and the second region or includes the first region, the second region, and the third region.

Specifically, FIG. 6(a) is a plan view of a battery 2000 according to the second embodiment. FIG. 6(b) is a cross-sectional view of the battery 2000 taken along VI-VI line in FIG. 6(a).

Referring to FIG. 6, the battery 2000 includes a current collector 1300a, a current collector 1300b, and a power generating element 500. The power generating element 500 includes a positive electrode layer 510, a negative electrode layer 520, and a solid electrolyte layer 530 disposed between the positive electrode layer 510 and the negative electrode layer 520. The power generating element 500 is laminated between and in contact with the current collector 1300a and the current collector 1300b. The solid electrolyte layer 530 is also disposed outside the positive electrode layer 510 and the negative electrode layer 520 in plan view and partially in contact with the current collector 1300a and the current collector 1300b. The current collector 1300a and the current collector 1300b have the same structure as the current collector 1300 according to Modification 3 of the first embodiment. The electron conductive material 30a contained in a first region 100a of the current collector 1300a is different from the electron conductive material 30b contained in a first region 100b of the current collector 1300b in constituent materials.

The current collector 1300a is an example first electrode current collector, and the current collector 1300b is an example second electrode current collector. The positive electrode layer 510 is an example first electrode layer, and the negative electrode layer 520 is an example second electrode layer.

In FIG. 6, the current collector 1300a and the current collector 1300b both have the same structure as the current collector 1300 according to Modification 3 of the first embodiment. However, only one of the current collector 1300a or the current collector 1300b may have the same structure as the current collector 1300 according to Modification 3 of the first embodiment.

The positive electrode layer 510 is laminated in contact with the first region 100a of the current collector 1300a, and the entire positive electrode layer 510 is located within the first region 100a in plan view. The negative electrode layer 520 is laminated in contact with the first region 100b of the current collector 1300b, and the entire negative electrode layer 520 is located within the first region 100b in plan view.

The solid electrolyte layer 530 is also disposed in contact with the side surfaces of the positive electrode layer 510 and the negative electrode layer 520 as viewed in the thickness direction. In other words, the solid electrolyte layer 530 is also disposed outside the positive electrode layer 510 and the negative electrode layer 520 in plan view. Thus, part of the solid electrolyte layer 530 is laminated in contact with the first region 100a and a third region 300a of the current collector 1300a and the first region 100b and a third region 300b of the current collector 1300b.

A second region 200a and a second region 200b both having insulating properties are disposed in the peripheral portions of the battery 2000 in plan view.

The positive electrode layer 510 contains, for example, a positive electrode material, such as an active material. The positive electrode layer 510 contains, for example, a positive electrode active material.

Examples of the material of the positive electrode active material may include various materials capable of intercalating and deintercalating ions, such as lithium, sodium, potassium, or magnesium ions.

When the positive electrode active material contained in the positive electrode layer 510 is a material capable of intercalating and deintercalating lithium ions, the positive electrode active material is, for example, lithium cobalt oxide composite oxide (LCO), lithium nickel oxide composite oxide (LNO), lithium manganese oxide composite oxide (LMO), lithium-manganese-nickel composite oxide (LMNO), lithium-manganese-cobalt composite oxide (LMCO), lithium-nickel-cobalt composite oxide (LNCO), or lithium-nickel-manganese-cobalt composite oxide (LNMCO).

Examples of the materials of the positive electrode layer 510 may include solid electrolytes, such as inorganic solid electrolytes. The inorganic solid electrolyte may be, for example, a sulfide solid electrolyte or an oxide solid electrolyte. The sulfide solid electrolyte may be, for example, a synthetic product composed of lithium sulfide (Li₂S) and phosphorus pentasulfide (P₂S₅). The sulfide solid electrolyte may be a sulfide, such as Li₂S—SiS₂, Li₂S—B₂S₃, or Li₂S-GeS₂, or may be a sulfide formed by adding at least one of Li₃N, LiCl, LiBr, Li₃PO₄, or Li₄SiO₄ to the above sulfide as an additive.

The oxide solid electrolyte may be, for example, Li₇La₃Zr₂O₁₂(LLZ), Li_{1.3}Al_{0.3}Ti_{1.7}(PO₄)₃(LATP), or (La,Li)TiO₃(LLTO).

The surface of the positive electrode active material may be coated with a solid electrolyte. Examples of the materials of the positive electrode layer 510 may include conductive materials, such as acetylene black, carbon black, graphite, and carbon fiber, and binders for binding, such as polyvinylidene fluoride.

The positive electrode layer 510 may be produced by, for example, applying a coating paste containing the materials of the positive electrode layer 510 kneaded with a solvent to the surface of a current collector, and drying the paste. To increase the density of the positive electrode layer 510, a positive electrode plate including the positive electrode layer 510 and the current collector may be pressed after drying. The positive electrode layer 510 has, for example, a thickness greater than or equal to 5 μm and less than or equal to 300 μm, but the thickness is not limited to this.

The negative electrode layer 520 contains, for example, a negative electrode material, such as an active material. The negative electrode layer 520 contains, for example, a negative electrode active material as an electrode material.

Examples of the negative electrode active material contained in the negative electrode layer 520 may include graphite and metal lithium. Examples of the material of the negative electrode active material include various materials capable of intercalating and deintercalating ions, such as lithium, sodium, potassium, or magnesium ions.

Examples of the materials of the negative electrode layer 520 may include solid electrolytes, such as inorganic solid electrolytes. Examples of inorganic solid electrolytes may include the materials illustrated as inorganic solid electrolytes used in the positive electrode layer 510. Examples of the materials of the negative electrode layer 520 may include conductive materials, such as acetylene black, carbon black, graphite, and carbon fiber, and binders for binding, such as polyvinylidene fluoride.

The negative electrode layer 520 may be produced by, for example, applying a coating paste containing the materials of the negative electrode layer 520 kneaded with a solvent to the surface of a current collector, and drying the paste. To increase the density of the negative electrode layer 520, a negative electrode plate including the negative electrode layer 520 and the current collector may be pressed after drying. The negative electrode layer 520 has, for example, a thickness greater than or equal to 5 μm and less than or equal to 300 μm, but the thickness is not limited to this.

The solid electrolyte layer 530 contains an electrolyte material. The electrolyte material may be a commonly known electrolyte for batteries. The solid electrolyte layer 530 may have a thickness greater than or equal to 5 μm and less than or equal to 300 μm, or a thickness greater than or equal to 5 μm and less than or equal to 100 μm.

The solid electrolyte layer 530 may contain a solid electrolyte. The battery 2000 may be, for example, an all-solid-state battery.

Examples of the solid electrolyte may include inorganic solid electrolytes. Examples of inorganic solid electrolytes may include the materials illustrated as inorganic solid electrolytes used in the positive electrode layer 510. The solid electrolyte layer 530 may contain, for example, a binder for binding, such as polyvinylidene fluoride, in addition to the electrolyte material.

The solid electrolyte layer 530 may be produced by, for example, applying a coating paste containing the materials of the solid electrolyte layer 530 kneaded with a solvent to the positive electrode layer 510 formed on a current collector and/or the negative electrode layer 520 formed on a current collector, and drying the paste.

The battery 2000 may be produced by, for example, laminating the solid electrolyte layer 530 between the positive electrode layer 510 formed on the current collector and the negative electrode layer 520 formed on the current collector. The power generating element 500 is accordingly laminated between the current collector and the current collector.

In the battery 2000 as described above, the second region 200a and the second region 200b both having insulating properties are disposed in the peripheral portions of the battery 2000 and suppress short-circuiting even when the current collectors come into contact with each other. In addition, the third region 300a and the third region 300b both containing the solid electrolyte are in contact with the solid electrolyte layer 530, so that the solid electrolyte of the third region 300a and the third region 300b is easily bonded to the solid electrolyte of the solid electrolyte layer 530. This configuration provides the battery 2000 with a tightly laminated structure. This configuration can further improve battery reliability.

### Modifications

Hereinafter, modifications of the second embodiment will be described below. In the description of the modifications below, the points different from the first embodiment or the second embodiment or the different points between the modifications will be mainly described, and description of common points will be omitted or simplified.

### Modification 1

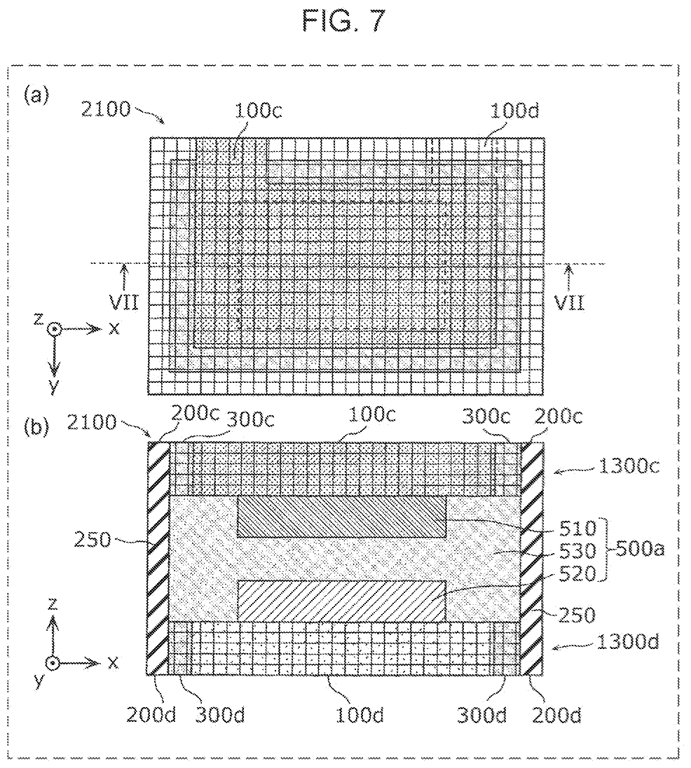

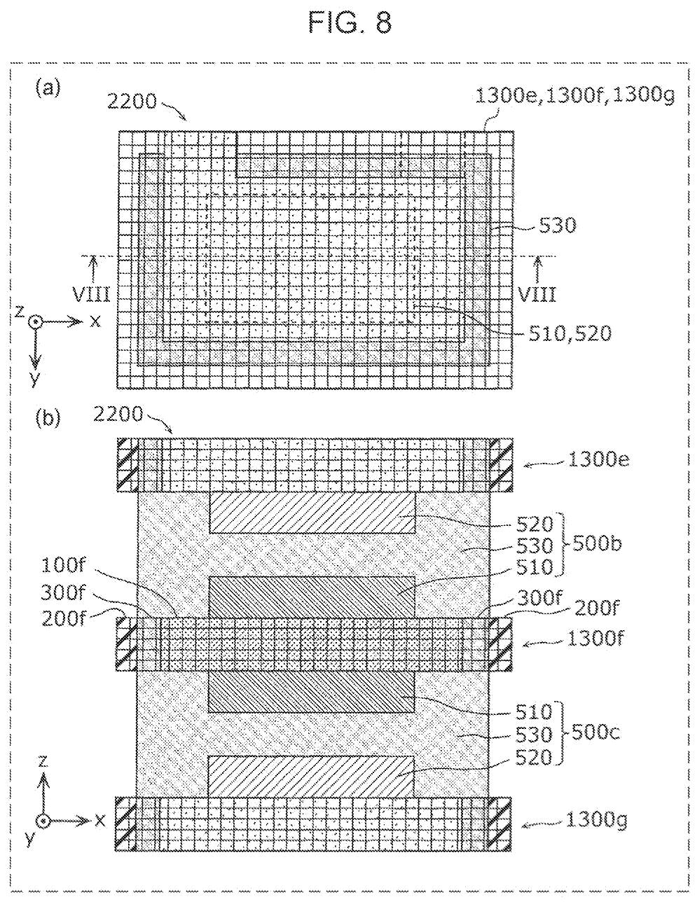

FIG. 7 illustrates a plan view and a cross-sectional view of an example of a battery according to Modification 1 of the second embodiment. The battery according to Modification 1 of the second embodiment is different from the battery according to the first embodiment in that the second regions of two current collectors are joined to each other.

FIG. 7(a) is a plan view of a battery 2100 according to Modification 1 of the second embodiment. FIG. 7(b) is a cross-sectional view of the battery 2100 taken along VII-VII line in FIG. 7(a).

Referring to FIGS. 7(a) and 7(b), the battery 2100 includes a current collector 1300c, a current collector 1300d, and a power generating element 500a. The current collector 1300c is an example first electrode current collector, and the current collector 1300d is an example second electrode current collector.

In the battery 2100, a second region 200c of the current collector 1300c is joined to a second region 200d of the current collector 1300d. The side surfaces of the power generating element 500a of the battery 2100 as viewed in the thickness direction are thus covered with an insulating material 250 contained in the second region 200c and the second region 200d. Part of a first region 100c of the current collector 1300c extends to the edge portion of the current collector 1300c, and part of a first region 100d of the current collector 1300d extends to the edge portion of the current collector 1300d. In other words, the side surfaces of the battery 2100 except the areas of the first region 100c and the first region 100d formed to draw current are covered with the insulating material 250 as viewed in the thickness direction.

The battery 2100 according to Modification 1 of the second embodiment is produced by, for example, the following method.

First, the power generating element 500a including the positive electrode layer 510, the negative electrode layer 520, and the solid electrolyte layer 530 is laminated between the current collector 1300c and the current collector 1300d by the same method as that for the battery 2000 according to the second embodiment. The second region 200c and the second region 200d in the resulting laminated body are thermally fused (thermally welded) to each other to produce the battery 2100.

To facilitate thermal fusion, the insulating material contained in the second region 200c and the second region 200d may be a thermoplastic resin. The reason for this is as described above.

Since the side surfaces of the power generating element 500a are also covered with the insulating material in the battery 2100 as described above, the insulating material can prevent contact of the power generating element 500a with other batteries. This configuration can further improve battery reliability.

### Modification 2

FIG. 8 illustrates a plan view and a cross-sectional view of an example of a battery according to Modification 2 of the second embodiment. The battery according to Modification 2 of the second embodiment is different from the battery according to the first embodiment in having two power generating elements.

FIG. 8(a) is a plan view of a battery 2200 according to Modification 2 of the second embodiment. FIG. 8(b) is a cross-sectional view of the battery 2200 taken along VIII-VIII line in FIG. 8(a).

Referring to FIGS. 8(a) and 8(b), the battery 2200 includes a current collector 1300e, a current collector 1300f, a current collector 1300g, a power generating element 500b, and a power generating element 500c. The current collector 1300f is an example first electrode current collector, and the current collector 1300e and the current collector 1300g are example second electrode current collectors. When the battery includes multiple first electrode current collectors or multiple second electrode current collectors, the multiple first electrode current collectors and the multiple second electrode current collectors may have the same structure or different structures.

The power generating element 500b is laminated in contact with the top surface of the current collector 1300f, and the power generating element 500c is laminated in contact with the bottom surface of the current collector 1300f. The power generating element 500b is disposed between the current collector 1300e and the current collector 1300f, and the power generating element 500c is disposed between the current collector 1300f and the current collector 1300g. The positive electrode layer 510 of the power generating element 500b and the positive electrode layer 510 of the power generating element 500c are both laminated in contact with a first region 100f of the current collector 1300f. The solid electrolyte layer 530 of the power generating element 500b and the solid electrolyte layer 530 of the power generating element 500c are both laminated in contact with a third region 300f of the current collector 1300f. In other words, in the battery 2200, the power generating element 500b has a laminated structure including layers laminated in a laminating order inverted from that in the power generating element 500c. The battery 2200 having a laminated structure is thus provided as a laminated battery with parallel connection.

As described above, in a battery including two or more power generating elements (the power generating element 500b and the power generating element 500c in FIG. 8) laminated on top of one another, a current collector including a first region, a second region, and a third region (the current collector 1300f including the first region 100f, a second region 200f, and the third region 300f in FIG. 8) is used as a current collector located between and in contact with two power generating elements. This configuration provides a laminated battery with parallel connection. In this case, the solid electrolyte in the third region of the current collector located between and in contact with two power generating elements is in contact with the adjacent solid electrolyte layers and functions like a liquid junction through which ions are transported between two power generating elements. A laminated battery with such parallel connection has a high capacity.

In such a laminated battery, the second region having insulating properties is disposed in the peripheral portion of each current collector as viewed in the thickness direction and suppresses short-circuiting even when the current collectors come into contact with each other. Since the third regions containing the solid electrolyte are in contact with the solid electrolyte layers, the solid electrolyte layer in each third region is easily bonded to the solid electrolyte of the solid electrolyte layers. This configuration provides a laminated battery with a tightly laminated structure and prevents or reduces misalignment between the power generating elements and the current collectors. This configuration can further improve battery reliability.

### Modification 3

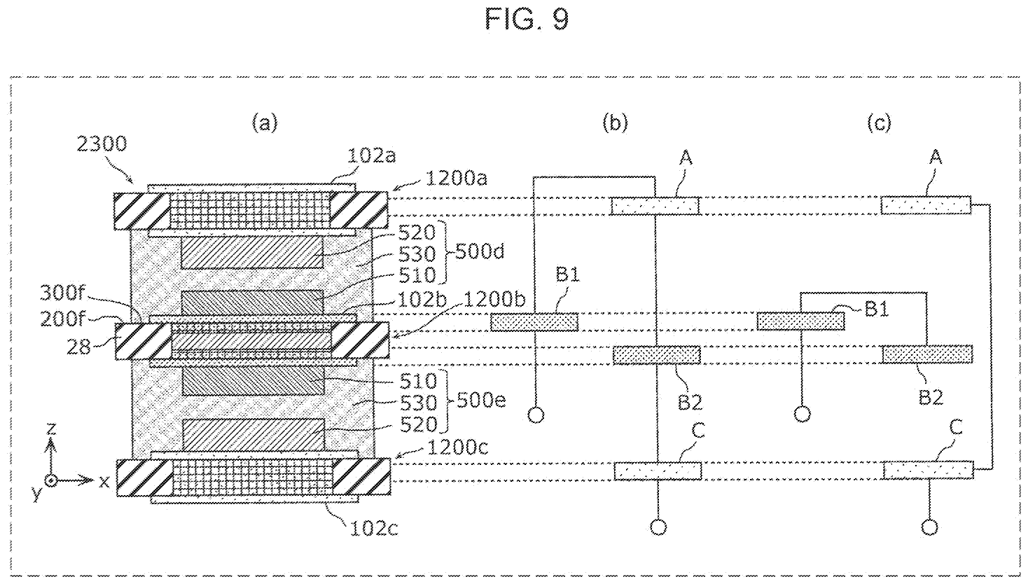

FIG. 9 illustrates a cross-sectional view of an example of a battery according to Modification 3 of the second embodiment and views of external connection examples. The battery according to Modification 3 of the second embodiment and the battery according to Modification 2 of the second embodiment are the same in having two power generating elements and different from each other in that the former battery allows two connection forms, series connection and parallel connection, through external connection.

FIG. 9(a) is a cross-sectional view of a battery 2300 according to Modification 3 of the second embodiment. FIGS. 9(b) and 9(c) illustrate external connection examples of the battery 2300.

Referring to FIG. 9(a), the battery 2300 includes a current collector 1200a, a current collector 1200b, a current collector 1200c, a power generating element 500d, and a power generating element 500e. The current collector 1200b is an example first electrode current collector, and the current collector 1200a and the current collector 1200c are example second electrode current collectors.

The power generating element 500d is laminated in contact with the top surface of the current collector 1200b, and the power generating element 500e is laminated in contact with the bottom surface of the current collector 1200b. The power generating element 500d is disposed between the current collector 1200a and the current collector 1200b, and the power generating element 500e is disposed between the current collector 1200b and the current collector 1200c. The positive electrode layer 510 of the power generating element 500d and the positive electrode layer 510 of the power generating element 500e are both laminated in contact with a first region 102b of the current collector 1200b. The current collector 1200b includes a third region 302b outside the first region 102b in plan view. The third region 302b contains a solid electrolyte supported on an insulating material 28.

Although not shown, like the first region 100c and the first region 100d shown in FIG. 7(a), a first region 102a of the current collector 1200a, the first region 102b of the current collector 1200b, and a first region 102c of the current collector 1200c extend to the edge portions of the respective current collectors, so that current can be drawn from the peripheral side surfaces of the current collectors. The current collector 1200b contains the insulating material 28 having no through-holes penetrating in the thickness direction, so that current does not flow between the power generating element 500d and the power generating element 500e. In other words, the upper surface and lower surface of the first region 102b are insulated from each other by the insulating material 28. The first region 102b thus has a structure that allows current above and below the insulating material 28 to be drawn from the peripheral side surface of the current collector.

FIGS. 9(b) and 9(c) schematically illustrate portions of the first region 102a, the first region 102b, and the first region 102c that extend to the edge portions of the respective current collectors. A portion of the first region 102a that extends to the edge portion of the corresponding current collector is an edge portion A, portions of the first region 102b that extend to the edge portion of the corresponding current collector are an edge portion B1 and an edge portion B2, and a portion of the first region 102c that extends to the edge portion of the corresponding current collector is an edge portion C.

The edge portion A is electrically connected to the negative electrode layer 520 of the power generating element 500d. The edge portion B1 is electrically connected to the positive electrode layer 510 of the power generating element 500d. The edge portion B2 is electrically connected to the positive electrode layer 510 of the power generating element 500e. The edge portion C is electrically connected to the negative electrode layer 520 of the power generating element 500e. Referring to FIG. 9(b), the battery 2300 may be a laminated battery in which the edge portion B1, the edge portion A, the edge portion B2, and the edge portion C are externally connected to one another in this order to establish series connection. Referring to FIG. 9(c), the battery 2300 may be a laminated battery in which the edge portion A and the edge portion C are externally connected to each other and the edge portion B1 and the edge portion B2 are externally connected to each other to establish parallel connection. The battery thus has a high capacity for parallel connection, and the battery has a high voltage for series connection.

As described above, in a battery including two or more power generating elements (the power generating element 500d and the power generating element 500e in FIG. 9) laminated on top of one another, a current collector in which the upper surface and lower surface of the first region are insulated from each other and that includes a first region, a second region, and a third region containing a solid electrolyte supported on an insulating material (the current collector 1200b including the first region 102b, a second region 202b, and the third region 302b in FIG. 9) is used as a current collector located between and in contact with two power generating elements, and the first region extends to the edge portion of the current collector in plan view. This configuration provides a battery that allows series connection or parallel connection through external terminals.

As described above, the second region having insulating properties is disposed in the peripheral portion of such a laminated battery as viewed in the thickness direction and suppresses short-circuiting even when the current collectors come into contact with each other. The third region containing the solid electrolyte supported on the insulating material is disposed outside the first region in plan view and prevents contact of the conductive material of the first region with other current collectors or the like to suppress short-circuiting. The solid electrolyte layer of the power generating element is integrated with the solid electrolyte of the third region to cover the top surface and side surfaces of the conductive material of the first region of the current collector. This configuration prevents or reduces misalignment between the current collector and the power generating element. This configuration can further improve battery reliability.

### Modification 4

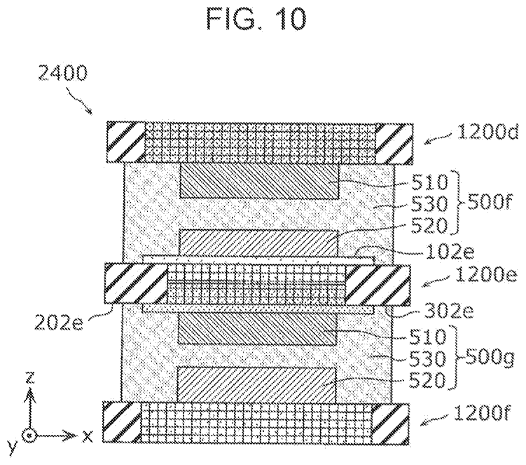

FIG. 10 is a cross-sectional view of an example of a battery according to Modification 4 of the second embodiment. The battery according to Modification 4 of the second embodiment and the battery according to Modification 3 of the second embodiment are the same in having two power generating elements and different from each other in that the former battery is a bipolar laminated battery that allows series connection without external connection.

Referring to FIG. 10, a battery 2400 includes a current collector 1200d, a current collector 1200e, a current collector 1200f, a power generating element 500f, and a power generating element 500g. The current collector 1200e is an example first electrode current collector, and the current collector 1200d and the current collector 1200f are example second electrode current collectors.

The power generating element 500f is laminated in contact with the top surface of the current collector 1200e, and the power generating element 500g is laminated in contact with the bottom surface of the current collector 1200e. The power generating element 500f is disposed between the current collector 1200d and the current collector 1200e, and the power generating element 500g is disposed between the current collector 1200e and the current collector 1200f. The negative electrode layer 520 of the power generating element 500f is laminated in contact with the top surface of a first region 102e of the current collector 1200e, and the positive electrode layer 510 of the power generating element 500g is laminated in contact with the bottom surface of the first region 102e of the current collector 1200e. In other words, the electrode layers having different polarities are laminated on the top surface and bottom surface of the current collector 1200e. In the battery 2400, the power generating element 500f and the power generating element 500g have a laminated structure in which layers are laminated in the same laminating order from above. The solid electrolyte layer 530 of the power generating element 500f and the solid electrolyte layer 530 of the power generating element 500g are independent of each other with the current collector 1200e therebetween, so that no ions are transported between the solid electrolyte layer 530 of the power generating element 500f and the solid electrolyte layer 530 of the power generating element 500g. This configuration provides a bipolar laminated battery with series connection.

As described above, in a battery including two or more power generating elements (the power generating element 500f and the power generating element 500g in FIG. 10) laminated on top of one another, a current collector including a first region, a second region, and a third region containing a solid electrolyte supported on an insulating material (the current collector 1200e including the first region 102e, a second region 202e, and a third region 302e in FIG. 10) is used as a current collector located between and in contact with two power generating elements, and electrode layers having different polarities are disposed on the top surface and bottom surface of the current collector. This configuration provides a bipolar battery with series connection.

In the battery 2400 shown in FIG. 10, current may be drawn from the top and bottom surfaces of the battery 2400, and part of each first region may extend to the edge portion of the corresponding current collector in order to draw current as shown in FIG. 7.

### Modification 5

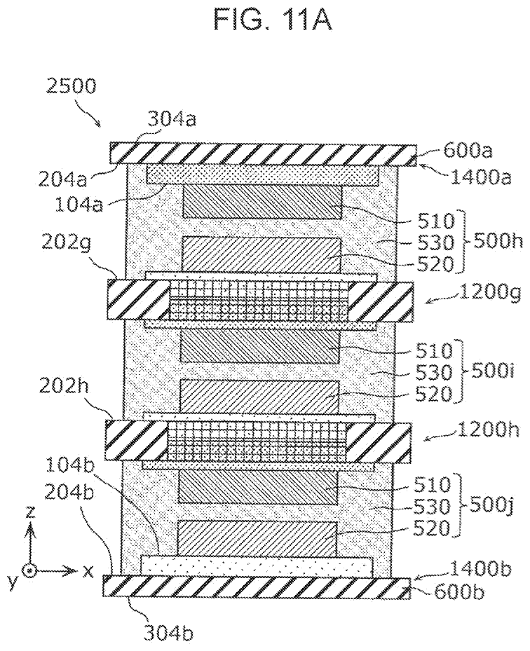

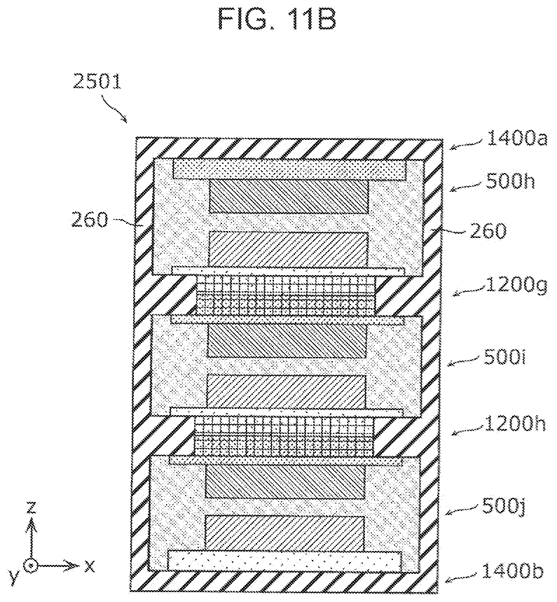

FIG. 11A is a cross-sectional view of one example of a battery according to Modification 5 of the second embodiment. FIG. 11B is a cross-sectional view of another example of the battery according to Modification 5 of the second embodiment. The battery according to Modification 5 of the second embodiment and the battery according to Modification 4 of the second embodiment are the same in terms of bipolar laminated battery with series connection and different from each other in the number of power generating elements and in having insulating layers.

Referring to FIG. 11A, a battery 2500 includes a current collector 1200g, a current collector 1200h, a current collector 1400a, a current collector 1400b, a power generating element 500h, a power generating element 500i, and a power generating element 500j. An insulating layer 600a made of an insulating material is formed in a top surface portion of the current collector 1400a laminated as the uppermost layer, and an insulating layer 600b made of an insulating material is formed in a bottom surface portion of the current collector 1400b laminated as the lowermost layer. The current collector 1400a and the current collector 1200h are example first electrode current collectors, and the current collector 1200g and the current collector 1400b are example second electrode current collectors.

In the current collector 1400a, an electron conductive material and a solid electrolyte are supported below the insulating layer 600a. In the current collector 1400b, an electron conductive material and a solid electrolyte are supported on the insulating layer 600b.

Although not shown, like the first region 100c and the first region 100d shown in FIG. 7(a), a first region 104a of the current collector 1400a and a first region 104b of the current collector 1400b extend to the edge portion of the corresponding current collector, so that current can be drawn from the peripheral side surfaces of the current collectors.

The power generating element 500h is disposed between and in contact with the current collector 1400a and the current collector 1200g, the power generating element 500i is disposed between and in contact with the current collector 1200g and the current collector 1200h, and the power generating element 500j is disposed between and in contact with the current collector 1200h and the current collector 1400b. The power generating element 500h, the power generating element 500i, and the power generating element 500g have a laminated structure in which layers are laminated in the same laminating order from above. The solid electrolyte layers 530 of the power generating element 500h, the power generating element 500i, and the power generating element 500j are independent of one another with the current collectors therebetween, so that no ions are transported between the solid electrolyte layers 530 of the power generating element 500h, the power generating element 500i, and the power generating element 500j. This configuration provides a bipolar laminated battery with series connection.

As described above, the insulating layers are formed in the top surface portion of the current collector laminated as the uppermost layer and in the bottom surface portion of the current collector laminated as the uppermost layer, and the second regions having insulating properties are disposed in the peripheral portions of other current collectors. In other words, the outer surfaces of the battery except the areas of the first regions extending to the edge portions of the current collectors are formed of material having no electron conductivity. This configuration can further reduce possibility of short-circuiting to improve battery reliability.

A battery 2501 shown in FIG. 11B is a battery in which a second region 204a of the current collector 1400a, a second region 202g of the current collector 1200g, a second region 202h of the current collector 1200h, and a second region 204b of the current collector 1400b, which are the second regions in the battery 2500 shown in FIG. 11A, are joined to one another. The side surfaces of the power generating element 500h, the power generating element 500i, and the power generating element 500j in plan view are covered with an insulating material 260. The battery 2500 shown in FIG. 11A includes the insulating layer 600a and the insulating layer 600b respectively formed in the uppermost part and the lowermost part. The battery 2501 shown in FIG. 11B except the areas of the first regions extending to the edge portions of the current collectors is entirely covered with the insulating material.

The battery 2501 is produced by thermally fusing (thermally welding) the second region 204a of the current collector 1400a, the second region 202g of the current collector 1200g, the second region 202h of the current collector 1200h, and the second region 204b of the current collector 1400b, which are the second regions in the battery 2500 shown in FIG. 11A, to one another.

The insulating material of the insulating layer 600a and the insulating layer 600b may be a thermoplastic resin and may be the same material as the insulating material used in the current collector 1200g and the current collector 1200h. The reason for this is that there is no difference in melting temperature, stress, and the like during thermal fusion to reduce possibility of strain, warpage, adhesive failure, and the like.

As described above, a bipolar laminated battery having a housing that can block the outside air can be produced by thermal fusion of the second regions of the current collectors included in the battery.

Many solid electrolytes used in all-solid-state batteries using alkali metals as mobile ions react with water in the atmosphere to degrade electrical characteristics. However, blocking the outside air prevents or reduces degradation of the electrical characteristics.

Since the thermoplastic resin used as the insulating material has a certain degree of water permeability, the battery may be installed in a laminate pack, a metal case, or the like.

### OTHER EMBODIMENTS

The current collectors and the batteries according to the present disclosure are described above on the basis of the embodiments, but the present disclosure is not limited to these embodiments. Various modifications of the embodiments that would be conceived by those skilled in the art, and forms constructed by combining some of components in the embodiments are also within the present disclosure without departing from the spirit of the present disclosure.

Various modifications, substitutions, additions, omissions, and the like may be made to the embodiments described above within the scope of the claims or the range of their equivalency.

The configurations described in the embodiments may be combined as appropriate.

In the embodiments, the solid electrolyte layer in the battery is also disposed on the side surfaces of the positive electrode layer and the negative electrode layer. However, the present disclosure is not limited to this configuration. The positive electrode layer, the negative electrode layer, and the solid electrolyte layer may be superposed on top of one another in plan view.

In the embodiments, the second region and the third region are formed outside the sides of the first region having a rectangular shape in plan view. However, the present disclosure is not limited to this configuration. The second region and the third region may be formed outside at least one side of the first region and, for example, may be formed only outside two opposite sides of the first region.

The battery current collector according to the present disclosure may be used as, for example, a current collector for all-solid-state lithium secondary batteries.

What is claimed is:

1. A battery current collector comprising:
a first region having electron conductivity;
a second region having insulating properties and located around the first region in plan view; and
a third region located between the first region and the second region in plan view,
wherein the first region contains an insulating material and an electron conductive material,
the second region contains the insulating material, and
the third region contains the insulating material and a solid electrolyte.

2. The battery current collector according to claim 1,
wherein the insulating material is a thermoplastic resin.

3. The battery current collector according to claim 2,
wherein the thermoplastic resin is at least one selected from the group consisting of polyethylene, polypropylene, and polyethylene terephthalate.

4. The battery current collector according to claim 1,
wherein at least part of the insulating material of the first region has a plurality of through-holes.

5. The battery current collector according to claim 1,
wherein the electron conductive material is a metal foil.

6. The battery current collector according to claim 1,
wherein the electron conductive material is an aggregate of metal particles or carbon material particles.

7. A battery comprising:
at least one first electrode current collector;
at least one second electrode current collector; and
at least one power generating element,
wherein the power generating element includes a first electrode layer, a second electrode layer, and a solid electrolyte layer disposed between the first electrode layer and the second electrode layer,
the power generating element is laminated between and in contact with the first electrode current collector and the second electrode current collector, and
at least one of the first electrode current collector or the second electrode current collector is the battery current collector according to claim 1.

8. The battery according to claim 7,
wherein the at least one power generating element includes a plurality of power generating elements, and
each of the power generating elements is laminated between and in contact with the corresponding first electrode current collector and the corresponding second electrode current collector.

9. The battery according to claim 7,
wherein each of the first electrode current collector and the second electrode current collector is the battery current collector, and
the second region of the first electrode current collector is at least partially joined to the second region of the second electrode current collector.

10. The battery according to claim 7,
wherein an insulating layer made of the insulating material is formed in a top surface portion of the first electrode current collector or the second electrode current collector laminated as an uppermost layer, or in a bottom surface portion of the first electrode current collector or the second electrode current collector laminated as a lowermost layer.

11. A method for producing a battery, the method comprising:
forming a first electrode layer and a second electrode layer; and
laminating a power generating element between a first electrode current collector and a second electrode current collector, the power generating element including the first electrode layer, the second electrode layer, and a solid electrolyte layer disposed between the first electrode layer and the second electrode layer,
wherein at least one of the first electrode current collector or the second electrode current collector is the battery current collector according to claim 1.

12. The method for producing a battery according to claim 11, further comprising: thermally fusing at least part of the second region of the first electrode current collector to at least part of the second region of the second electrode current collector; and
wherein each of the first electrode current collector and the second electrode current collector is the battery current collector.
